(19) United States
(12) Patent Application Publication
(10) Pub. No.: US 2010/0212670 A1
(43) Pub. Date: Aug. 26, 2010

(54) Ported Respirator Mask for In Situ Respirator Testing and Method of Use

(76) Inventors: Amir H. Amighi, Minneapolis, MN (US); Frederick R. Quant, Shoreview, MN (US); Derek R. Oberreit, Roseville, MN (US)

Correspondence Address: Moore & Hansen, PLLP, 225 South Sixth Street, Suite 4850, Minneapolis, MN, 55402, US

(21) Appl. No.: 12/706,568

(22) Filed: Feb. 16, 2010

Related U.S. Application Data
(60) Provisional application No. 61/154,268, filed on Feb. 20, 2009.

(51) Int. Cl. A62B 18/08; G01M 3/04

(52) U.S. Cl. 128/206.21; 73/40

(57) ABSTRACT

Methods and systems to enable ported respirator masks to be tested in situ to ensure that they are used effectively, including the ported masks themselves.

### CROSS-REFERENCE TO RELATED APPLICATION

This application claims the benefit of U.S. provisional patent application No. 61/154,268 filed Feb. 20, 2009.

### TECHNICAL FIELD

This application pertains to ported respirator masks and in situ testing of the same to ensure that they are used effectively.

### BACKGROUND

Current protocols for fit testing of respirators, including the so-called N95 respirator (which is rated to filter 95% of ambient particles above a certain size), are focused on testing whether the respirator user is capable of fitting a disposable or customized non-disposable respirator to achieve the required standard (e.g., the 95% requirement).

In the case of disposable respirators, a specifically shaped bi-directional opening (hole) is punched in a test respirator and a probe portion of a testing system is attached to the respirator at the location of the hole. This is known as “probing the respirator.” The user fits the modified respirator to their face and follows a protocol to test whether they are able to adjust that specific modified respirator to meet the N95 requirement. If so, it is presumed that they know how to don another respirator—and, more speculatively, will actually do so in the future—to meet the same requirement. In other words, current fit testing protocols actually test the education of the user and not the performance of the respirator itself. Also, once probed, disposable respirators must be discarded and not used in situ, even if sanitized.

Another approach is the use of a so-called “pre-probed respirator” which is a non-disposable respirator intended for use during only the fit testing. It is not a disposable respirator intended for actual use, and therefore it cannot be used during in situ testing. Unless each user undergoing testing is provided with their own pre-probed respirator, shared use of such a device presents various contamination and sterilization issues that can be critical in the context of a pandemic, bio-hazard terrorist attack, or the like.

### SUMMARY

In general terms, the products, methods and systems according to this application improve the effectiveness of ported respirator masks in actual use. The disclosed embodiments increase the reliability of such masks with respect to their design criteria, particularly their ability to meet the so-called N95 requirement.

### BRIEF DESCRIPTION OF THE DRAWINGS

The accompanying drawings show a particular embodiment as an example, and are not intended to limit the scope of this disclosure. In particular, any values and information listed for components are preferred but not required. Similarly, the dimensions are shown by way of illustration only and are not critical to the scope of the application unless otherwise specified to be critical.

FIG. 1 is a schematic diagram of a system for fit testing.

FIGS. 2-4 are schematic cross-sectional views of various types of port for a respirator.

FIG. 5 is a schematic cross-sectional view of a field-adaptable type of port for a respirator

### DETAILED DESCRIPTION

In the following discussion, it should be understood that descriptions of methods are applicable to embodiments in the form of products or systems, and vice versa, as would be understood by those skilled in the art, even in the absence of terminology specific to one type of embodiment or the other.

Workers in hospitals and emergency services organizations are required to be trained in the use of respirators, including tests to insure that the proper size, fit and seal of the respirator provides the specified protection. Such “fit testing” is specific to the individual worker because it relies on the workers' facial anatomy, i.e., the degree to which the mask conforms closely to the user's cheeks, nose bridge, etc.

When considering contingency plans for a pandemic, bio-hazard terrorist attack, or the like, such organizations need to consider whether workers will fear that they will not be able to attain adequate protection from hazardous agents by the use of a respirator. The lack in confidence by some workers may be exasperated if the worker's only knowledge of a successful fit of the respirator occurred at the time of the currently required respirator fit test, which tests are required only annually.

FIG. 1 illustrates the general operation of systems and methods within the scope of this application. These systems and methods are further disclosed below in the specific context of sample embodiments. Each embodiment is based on the concept of improving the reliability of fit testing for a respirator mask. Thus, specific features or one embodiment are also applicable to each of the other embodiments as appropriate.

Respirator 100 is designed and certified to include (or be provided in the field with) a port 110 to allow the user donning it (not shown) to connect respirator 100 to a fit testing device 200, such as by use of sampling probe 220. This allows the user to verify that respirator 100 is working and fitted correctly to achieve the desired level of filtration (for example, N95).

Fit testing device 200 includes a condensation particle counter (CPC, or sometimes “CNC”) or other functionally equivalent particle detection device 210, such as a laser particle spectrometer (LPS). This component detects particles inside respirator 100 and compares the number detected to the number of particles in the ambient conditions outside respirator 100. The detection system would typically be located in areas where respirators would be provided for use.

Currently, N95 respirators are not supplied with a measurement port and are not allowed to be used once a port has been applied. Thus, the benefit of certified respirators that have a port (or can be provided with a port in the field without losing certification) is that they allow a user to verify the fit of a respirator and then continue to use it, without having to discard it and donning a new non-ported respirator.

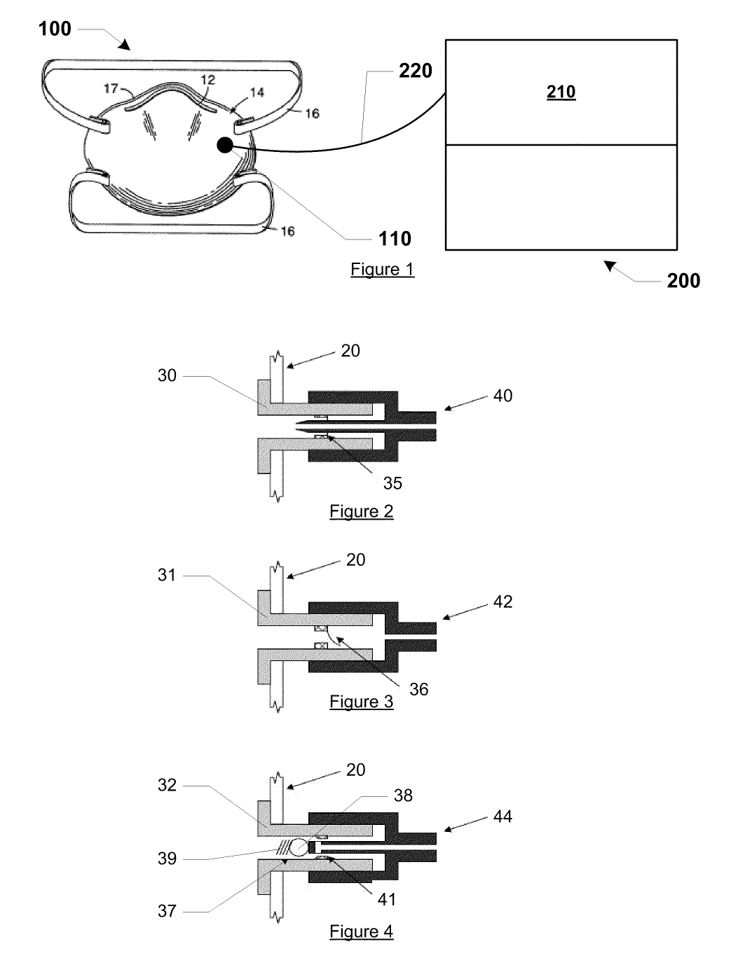

FIGS. 2-4 illustrate schematically several possible variations on the theme of a respiratory (one-way outward) port for a ported respirator. In all such variations, the port is sealed against inflow from outside the respirator.

In FIG. 2, mask wall 20 supports port 30 such that sample probe head 40 may removably penetrate port 30 through resealable septum 35.

In FIG. 3, mask wall 20 supports port 31 such that sample probe head 42 may hermetically embrace port 31, enabling a sealing flapper 36 to open within port 31.

In FIG. 4 mask wall 20 supports port 32 such that sample probe head 44 may removably penetrate port 32 and open spring loaded ball valve 37. It does so by displacing ball 38 from valve seat 41 against the compressive force provided by spring 39.

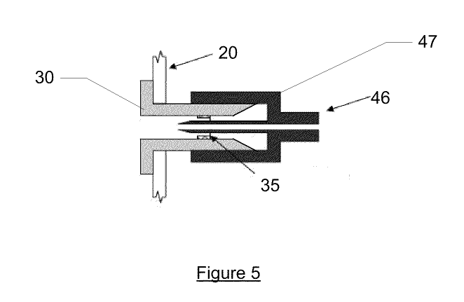

FIG. 5 illustrates schematically that a port may be implemented in the form of an adapter for converting, in the field, a mask which is otherwise unsuitable for use with the invention into a suitable mask. Thus, using a port having a resealable septum (see FIG. 2), the port is adapted to be added to the respirator in the field after manufacture of the respirator is completed without the port. In the specific embodiment illustrated, port 30 is sharpened at points 47 to pierce mask wall 20 and snap or otherwise attach by a conventional mechanism (not shown) to sample probe head 40. The combination operates as before. A similar approach may be taken with either of the ports illustrated in FIGS. 3-4. Thus, it should be understood that reference to a “ported” respirator generally includes either a port provided with the respirator (i.e., added to the respirator during manufacture) or a port provided in the field as described above.

FIGS. 2-5 are examples only. Other forms of port may be supported by the mask wall to enable coupling between the sample probe and the volume within the mask through the port. For example, while FIG. 4 illustrates ball valve 37, other valve designs may be used provided they operate in the same manner in aspects relevant to the invention as claimed below.

### General Considerations

In any embodiment, ported respirator 100 may otherwise be suited for any application for which fit testing is desirable, including (without limitation) respirator types such as disposable (filtering-facepiece) respirators (including, without limitation, N95 respirators), half-mask and full-mask, powered air purifying respirators (PAPRs) and self-contained breathing apparatus (SCBA) masks.

In any embodiment, the port 110 must provide a hermetic seal preventing inspiration (flow from outside the respirator to the user) when the sampling probe is removed. However, the port sealing method may be any of a flapper valve (or valves), a spring-loaded valve (or valves), a septum (or septa), a removable (and/or replaceable) cap (or caps). The port may be designed for either single use or repeated use.

Except for features specific to this invention as described above and claimed below, the systems, methods, and products described here may incorporate features and technology known in the art, including those features and methods disclosed in any of the following, each of which is incorporated in its entirety by reference:

U.S. Pat. Nos. 6,125,845; 6,435,009; 6,955,170; 7,343,783; and 7,407,531.

US Patent Application Publications 2004/0223876; 2004/0224293; 2006/0048783; 2007/0044803; 2007/0295331; and 2008/0110469.

We claim:

1. A system for improving use of a respirator by a user, comprising:
a) a respirator suitable for in situ use despite the respirator having a port; and
b) a system for fit testing of the ported respirator to the user.

2. The system of claim 1, in which the port is sealed against inflow from outside the respirator by at least one of the group consisting of: at least one flapper valve, at least one spring-loaded valve, at least one septum, at least one removable cap, and at least one replaceable cap.

3. The system of claim 1, in which the port is added to the respirator in the field after manufacture of the respirator is completed without the port.

4. The system of claim 1, in which the system for fit testing of the ported respirator to the user detects a number of particles inside the respirator and compares the number detected to a number of particles in ambient conditions outside the respirator.

5. The system of claim 1, in which the system for fit testing of the ported respirator to the user is a condensation particle counter.

6. The system of claim 1, in which the system for testing fit of the ported respirator to the user is a laser particle spectrometer.

7. The system of claim 1, in which the system for testing fit of the ported respirator to the user detects a number of particles inside the respirator and compares the number detected to a number of particles in ambient conditions outside the respirator.

8. A method of improving use of a respirator by a user, comprising:
a) providing a respirator with a port;
b) providing a system for fit testing of the ported respirator by the user;
in which the respirator is suitable for in situ use by the user after the fit testing.

9. The method of claim 8, in which the port is sealed against inflow from outside the respirator by at least one of the group consisting of: at least one flapper valve, at least one spring-loaded valve, at least one septum, at least one removable cap, and at least one replaceable cap.

10. The method of claim 8, in which the respirator is provided with the port by adding the port to the respirator in the field after manufacture of the respirator is completed without the port.

11. The method of claim 8, in which the system for fit testing of the ported respirator to the user detects a number of particles inside the respirator and compares the number detected to a number of particles in ambient conditions outside the respirator.

12. A respirator for in situ use, comprising a respirator material for supporting a port adapted for fit testing of the respirator by a user, in which in which the respirator is suitable for in situ use by the user after the fit testing.

13. The respirator of claim 10, in which the port is sealed against inflow from outside the respirator by at least one of the group consisting of: at least one flapper valve, at least one spring-loaded valve, at least one septum, at least one removable cap, and at least one replaceable cap.

14. The respirator of claim 1, in which the port is adapted to be added to the respirator in the field after manufacture of the respirator is completed without the port.
